(19) United States
(12) Patent Application Publication
(10) Pub. No.: US 2026/0301099 A1
(43) Pub. Date: Oct. 1, 2026

(54) INFORMATION PROCESSING DEVICE, INFORMATION PROCESSING METHOD, AND NON-TRANSITORY COMPUTER-READABLE RECORDING MEDIUM

(71) Applicant: Panasonic Intellectual Property Management Co., Ltd., Osaka (JP)

(72) Inventors: Nobuhiko WAKAI, Tokyo (JP); Shigehiro IIDA, Tokyo (JP)

(21) Appl. No.: 19/564,719

(22) Filed: Mar. 12, 2026

(30) Foreign Application Priority Data
Mar. 31, 2025 (JP) 2025-058423

(51) Int. Cl. G06Q 50/40

(52) U.S. Cl. CPC G06Q 50/40

(57) ABSTRACT

An information processing device acquires behavior amount data indicating a behavior amount of a user, acquires boarding/alighting point information indicating a boarding/alighting point of a transportation means used by the user, specifies an actual boarding/alighting point region where the boarding/alighting point is regarded as substantially existing in a predetermined region where the user acts, from a positional relationship between the boarding/alighting points, calculates a boarding/alighting point density which is a substantial density of the boarding/alighting points in the predetermined region based on the predetermined region and the actual boarding/alighting point region, corrects the behavior amount indicated by the behavior amount data according to the boarding/alighting point density, executes profiling for estimating an interest of the user based on a correction behavior amount that is the corrected behavior amount, and outputs a result of the profiling.

### FIELD OF INVENTION

The present disclosure relates to a user profiling technique.

### BACKGROUND ART

Technology development for estimating an interest of a user using behavior data generated from a behavior of the user is in progress. For example, Patent Literature 1 discloses a technique of estimating a context corresponding to whereabouts of a user and a time period when a content distribution request is accepted, determining a model that is corresponding to the estimated context and estimates an interest of the user in content, and determining content to be distributed to the user using the determined model.

Patent Literature 1: JP 2017-146683 A

However, in the above-described conventional technology, it is not considered that the behavior amount of the user varies according to the traffic environment of the region where the user behaves, and thus, further improvement is required to accurately estimate the interest of the user.

### SUMMARY OF THE INVENTION

An object of the present disclosure is to provide a technique for estimating an interest of a user by suppressing an influence of a variation component of a behavior amount according to a traffic environment of a region.

An information processing device according to one aspect of the present disclosure is an information processing device including a processor, in which the processor is configured to execute: acquiring behavior amount data indicating a behavior amount of a user; acquiring boarding/alighting point information indicating a boarding/alighting point of a transportation means used by the user; specifying an actual boarding/alighting point region where the boarding/alighting point is regarded as substantially existing in a predetermined region where the user acts, from a positional relationship between the boarding/alighting points; calculating a boarding/alighting point density which is a substantial density of the boarding/alighting points in the predetermined region based on the predetermined region and the actual boarding/alighting point region; correcting the behavior amount indicated by the behavior amount data according to the boarding/alighting point density; executing profiling for estimating an interest of the user based on a correction behavior amount that is the corrected behavior amount; and outputting a result of the profiling.

According to the present disclosure, it is possible to estimate an interest of a user by suppressing an influence of a variation component of a behavior amount according to a traffic environment of a region.

### BRIEF DESCRIPTION OF THE DRAWINGS

FIG. 1 is a block diagram illustrating an example of a configuration of an information processing system according to an embodiment of the present disclosure;

FIG. 2 is a flowchart illustrating an example of processing of an information processing device according to the embodiment of the present disclosure;

FIG. 3 is a diagram illustrating an outline of processing of specifying an actual boarding/alighting point region;

FIG. 4 is a diagram illustrating an outline of processing of specifying an actual boarding/alighting point region;

FIG. 5 is a flowchart illustrating details of processing of specifying an actual boarding/alighting point region;

FIG. 6 is a graph showing a correlation coefficient between the number of steps per day and a transportation means;

FIG. 7 is a flowchart in a first modification of the embodiment;

FIG. 8 is an explanatory diagram of processing of a second modification; and

FIG. 9 is an explanatory diagram of processing of a second modification.

### DETAILED DESCRIPTION

This application is based on Japanese Patent application No. 2025-058423 filed in Japan Patent Office on Mar. 31, 2025, the contents of which are hereby incorporated by reference.

### Knowledge Underlying Present Disclosure

Whether the user prefers the activity inside or outside the home is basic information indicating the feature of the user. The behavior of “movement” performed by walking, running, or the like is a behavior commonly performed by all users in daily life, unlike intense sports or the like. Therefore, information generated by movement of the user, such as the number of steps, speed, and acceleration due to walking or running, can be used as useful input information when performing profiling for analyzing the feature of the user.

Among them, the “number of steps” generated from the movement behavior of the user such as “walking” and “running” is convenient for comparing behavior tendencies of a plurality of users, and is useful for estimating an interest of the user. In addition, the “number of steps” is susceptible to human thought. For example, when viewed in time series, if the “number of steps” increases, it can be estimated that a predetermined user wakes up health-conscious and is interested in health. Furthermore, when the “number of steps” increases, it is possible to determine that the user tends to go out further in consideration of the position information of the user and the like. Furthermore, considering the “number of steps” and the position information or event information of the place where the user goes, it is possible to estimate the degree of interest of the user in the others.

In general, in a region where the bus network is included, the user uses the bus more frequently, and thus the “number of steps” tends to decrease. This is because bus stops are densely arranged, and the user can reach the bus stop without walking so much from home.

On the other hand, in a region where a railway network is provided, the user walks more frequently. This is because railway stations are arranged sparsely compared to bus stops, and the number of steps from home to a railway station increases.

Therefore, if the “number of steps” of the user is uniformly handled without considering the traffic environment in the region, and the interest of the user is estimated from the “number of steps” of the user, the interest of the user cannot be accurately estimated. For example, it is not appropriate to conclude that the user has a low interest in health just because the number of steps of the user in a region where the number of steps tends to decrease, such as a place with a bus stop, is small. On the other hand, it is not appropriate to conclude that the user has a high interest in health just because the number of steps of the user is large in a region where the number of steps tends to increase where a railway network is established.

Here, in order to remove the influence of the change in the number of steps according to the traffic environment of the region, a method of increasing or decreasing the number of steps of the user according to the boarding/alighting point density such as bus stops or railway stations is also considered.

However, it has been found that there is a region where it can be regarded that there is a boarding/alighting point substantially from the arrangement relationship of the boarding/alighting points in the region. Therefore, when the density of the boarding/alighting points is calculated, it is necessary to consider such a region.

The present disclosure has been made based on such findings.
(1) An information processing device according to one aspect of the present disclosure is an information processing device including a processor, in which the processor is configured to execute: acquiring behavior amount data indicating a behavior amount of a user; acquiring boarding/alighting point information indicating a boarding/alighting point of a transportation means used by the user; specifying an actual boarding/alighting point region where the boarding/alighting point is regarded as substantially existing in a predetermined region where the user acts, from a positional relationship between the boarding/alighting points; calculating a boarding/alighting point density which is a substantial density of the boarding/alighting points in the predetermined region based on the predetermined region and the actual boarding/alighting point region; correcting the behavior amount indicated by the behavior amount data according to the boarding/alighting point density; executing profiling for estimating an interest of the user based on a correction behavior amount that is the corrected behavior amount; and outputting a result of the profiling.

According to this configuration, the behavior amount of the user is corrected in accordance with the boarding/alighting point density of the transportation means, and the interest of the user is estimated based on the correction behavior amount which is a corrected behavior amount. As a result, it is possible to estimate the interest of the user by suppressing the influence of the variation component of the behavior amount of the user according to the traffic environment of the region. Furthermore, in this configuration, an actual boarding/alighting point region that can be regarded as substantially existing is specified from a positional relationship of boarding/alighting points, and a boarding/alighting point density that is a substantial boarding/alighting point density is calculated from the region and the actual boarding/alighting point region. Therefore, the interest of the user can be accurately estimated using the substantial boarding/alighting point density.
(2) In the information processing device according to (1), the behavior amount may be calculated by statistically processing behavior data indicating a behavior of the user.

According to this configuration, the behavior amount of the user can be accurately calculated based on the behavior data.
(3) In the information processing device according to (1) or (2), the boarding/alighting point may include a bus stop.

According to this configuration, since the correction behavior amount is calculated such that the variation component of the behavior amount corresponding to the bus stop is removed from the behavior amount, the interest of the user in the region where the bus stop is located can be accurately estimated.
(4) In the information processing device according to any one of (1) to (3), the correcting of the behavior amount may include acquiring terrain information indicating a distribution of inclinations in the predetermined region, and calculating an inclination degree of the predetermined region based on the terrain information, and correcting the boarding/alighting point density so that the smaller the inclination degree, the smaller the boarding/alighting point density.

The variation component of the behavior amount depends not only on the local traffic environment but also on the inclination degree of the terrain of the region. For example, a user in the region where the inclination degree is small tends to decrease the frequency of use of transportation means in the region, and as a result, the variation component of the behavior amount according to the traffic environment tends to increase. In this configuration, the boarding/alighting point density is corrected such that the smaller the inclination degree, the smaller the boarding/alighting point density. Therefore, it is possible to estimate the interest of the user in consideration of the variation component of the behavior amount according to the terrain.
(5) In the information processing device according to any one of (1) to (4), the specifying of the actual boarding/alighting point region may include, under a constraint that a boarding/alighting point region including the boarding/alighting point cannot be entered, moving a probe having a shape corresponding to the boarding/alighting point region in a search region including at least the predetermined region to specify a region that the probe cannot reach, and specifying the specified region and the boarding/alighting point region as the actual boarding/alighting point regions.

According to this configuration, it is possible to accurately specify the actual boarding/alighting point region where the boarding/alighting point can be regarded as substantially existing using the probe.
(6) In the information processing device according to (5), the boarding/alighting point region may be a quadrangle, and the probe may be a quadrangle larger in size than the boarding/alighting point region.

According to this configuration, since a quadrangular probe having a size larger than that of the boarding/alighting point region is moved on the search region, it is possible to accurately find a region that the probe cannot reach.
(7) In the information processing device according to (5) or (6), the boarding/alighting point region may be circular, and the probe may be circular.

According to this configuration, it is possible to accurately find a region that cannot be reached by the probe using the circular probe.
(8) In the information processing device according to any one of (5) to (7), the search region may be set so as to surround a periphery of the predetermined region, and may include a padding region having a shape in which the probe is movable, and the predetermined region.

According to this configuration, since the padding region is set around the predetermined region, the probe can reliably search the entire region of the predetermined region. For example, even in a predetermined region in which the boarding/alighting points are arranged so as to be divided at the center, the probe can search the entire region of the predetermined region while bypassing the boarding/alighting points through the padding region.
(9) In the information processing device according to any one of (1) to (8), the correcting of the behavior amount may include in a case of a user who uses a transportation means having a tendency that the behavior amount decreases as the number of the boarding/alighting points increases, increasing the behavior amount as the boarding/alighting point density increases.

According to this configuration, for the user who uses the transportation means having a tendency to decrease the behavior amount as the number of boarding/alighting points increases, the behavior amount increases as the boarding/alighting point density increases. As a result, the behavior amount of the user who uses such transportation means can be increased, and the interest of the user can be accurately estimated.
(10) In the information processing device according to any one of (1) to (9), the correcting of the behavior amount may include, in a case of a user who uses a transportation means having a tendency that the behavior amount increases as the number of the boarding/alighting points increases, decreasing the behavior amount as the boarding/alighting point density increases.

According to this configuration, for the user who uses the transportation means having a tendency to increase the behavior amount as the number of boarding/alighting points increases, the behavior amount decreases as the boarding/alighting point density increases. As a result, the behavior amount of the user who uses such transportation means can be reduced, and the interest of the user can be accurately estimated.
(11) In the information processing device according to any one of (1) to (10), the behavior amount may be a walking amount.

According to this configuration, it is possible to accurately estimate the interest of the user by calculating the substantial walking amount of the user from which the variation component of the number of steps according to the traffic environment has been removed.

The present disclosure can also be implemented as an information processing program for causing a computer to execute each characteristic configuration included in an information update method as described above, or as an information processing system operated by the information processing program. Further, it is needless to say that such a computer program can be distributed via a computer-readable non-transitory recording medium such as a CD-ROM or via a communication network such as the Internet.
(12) An information processing method according to another aspect of the present disclosure is an information processing method executed by a computer, the method including: acquiring behavior amount data indicating a behavior amount of a user; acquiring boarding/alighting point information indicating a boarding/alighting point of a transportation means used by the user; specifying an actual boarding/alighting point region where the boarding/alighting point is regarded as substantially existing in a predetermined region where the user acts, from a positional relationship between the boarding/alighting points; calculating a boarding/alighting point density which is a substantial density of the boarding/alighting points in the predetermined region based on the predetermined region and the actual boarding/alighting point region; correcting the behavior amount indicated by the behavior amount data according to the boarding/alighting point density; executing profiling for estimating an interest of the user based on a correction behavior amount that is the corrected behavior amount; and outputting a result of the profiling.
(13) A non-transitory computer-readable recording medium that records an information processing program according to still another aspect of the present disclosure causes a computer to execute: acquiring behavior amount data indicating a behavior amount of a user; acquiring boarding/alighting point information indicating a boarding/alighting point of a transportation means used by the user; specifying an actual boarding/alighting point region where the boarding/alighting point is regarded as substantially existing in a predetermined region where the user acts, from a positional relationship between the boarding/alighting points; calculating a boarding/alighting point density which is a substantial density of the boarding/alighting points in the predetermined region based on the predetermined region and the actual boarding/alighting point region; correcting the behavior amount indicated by the behavior amount data according to the boarding/alighting point density; executing profiling for estimating an interest of the user based on a correction behavior amount that is the corrected behavior amount; and outputting a result of the profiling.

Each of embodiments to be described below illustrates a specific example of the present disclosure. Numerical values, shapes, components, steps, order of steps, and the like of the embodiments below are merely examples, and are not intended to limit the present disclosure. Further, a component not described in an independent claim representing a highest concept among components in the embodiments below is described as an optional component. In all the embodiments, respective contents can be combined.

### EMBODIMENT

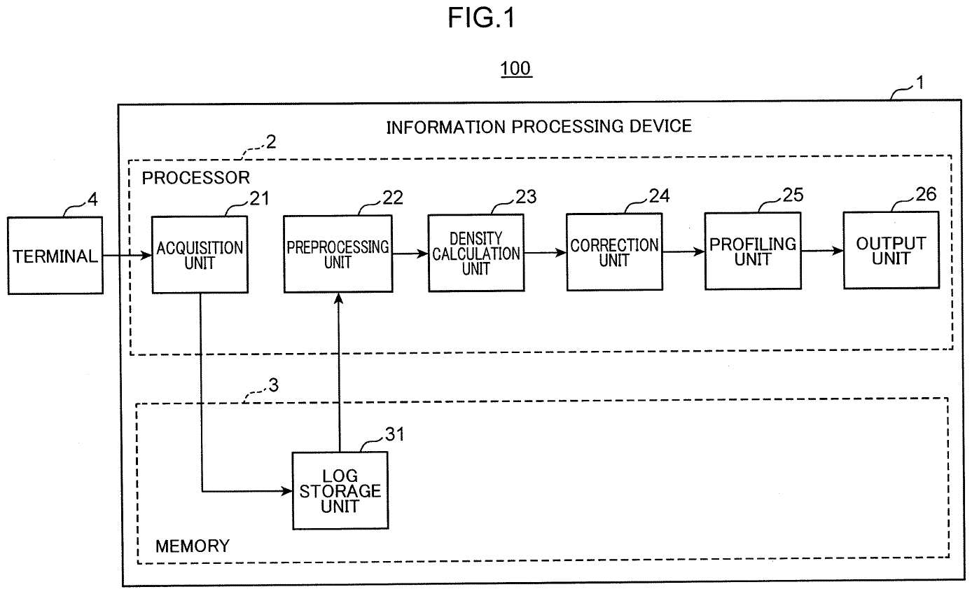

FIG. 1 is a block diagram illustrating one example of a configuration of an information processing system 100 in an embodiment of the present disclosure. The information processing system 100 includes an information processing device 1 and a terminal 4. The information processing device 1 includes, for example, a computer such as a cloud server or an edge server. The information processing device 1 and the terminal 4 are connected via a network. The network may be, for example, a wide region communication network such as the Internet or a local area network. The information processing device 1 may be mounted on the terminal 4.

The terminal 4 is a device that acquires information of a user to be subjected to information processing. The terminal 4 is, for example, a smartphone, a personal computer, a wearable terminal, a physical measurement device, or the like. The wearable terminal is, for example, a smart glass, a smart watch, or the like. The physical measurement device is, for example, a pedometer. Note that aspects of the terminal 4 are not limited to these examples.

The number of terminals 4 may be one or more. The terminal 4 inputs the acquired log of the target user (hereinafter, a user log) to the information processing device 1 at a predetermined timing. In the embodiment, the user log is behavior data indicating user's behavior. The behavior data is, for example, the number of steps of the user, the number of times of application operations on application software (hereinafter, an application) of the user, the number of times of operations on home appliances of the user, position information of the user, and the like. The position information of the user is acquired by, for example, a GPS sensor.

The application is, for example, an application that invites the user to take a walk in order to promote the health of the user. Specifically, the application accepts posts of recommended visit spots from users and posts the visit spots on a bulletin board that can be browsed by all users. The application receives a comment on the visit spot from another user, and posts the comment on the bulletin board in association with the visit spot. As a result, the application can motivate the user to visit the visit spot and take a walk. Further, the user can get to know other users through comments, and a human network can be established.

The position information of the user is used to specify a behavior range of the user. Examples of the home appliances include a washing machine, a television, a vacuum cleaner, and a refrigerator.

The behavior data may include behavior data recorded at regular time intervals (for example, every 1 hour or every 10 minutes, etc.) and behavior data recorded irregularly. The behavior data at regular time intervals is, for example, position information of the user acquired by a GPS sensor. On the other hand, the behavior data recorded irregularly is an application operation. The application operation is, for example, screen switching, posting, comment, a stamp indicating “like” in the application, and the like. The information processing device 1 uses at least one of behavior data recorded at regular time intervals and behavior data recorded irregularly.

In the present embodiment, data indicating an amount of exercise such as the number of steps, the number of going-out, a going-out distance, and a distance in which the user takes a walk can be employed as the behavior data. For example, the terminal 4 calculates the number of steps by dividing the movement distance calculated from the position information by the average stride length (for example, 70 cm). The distance in which the user takes a walk is not a simple walking distance but a distance in which the user takes a walk. The terminal 4 may calculate the walking distance by distinguishing for each behavior content such as walking and movement to a destination. The walking distance for each behavior content can be determined from an operation on the application or the like. For example, the terminal 4 displays information regarding a spot such as a park on the terminal 4 by the user operating the application, and calculates a movement distance calculated in a time period in which the user browses the information as a distance in which the user takes a walk. Note that the behavior data may be information generated by movement of the user, such as walking or running of the user. The information generated by the user's movement includes speed and acceleration in addition to the number of steps.

For example, the terminal 4 may count the number of times the user goes out of the house from the inside of the house by comparing the position information with the position information of the user's house, and calculate the counted number of times as the number of going-out. The terminal 4 calculates, for example, a movement distance of the user outside the region of the house as a going-out distance. The region of the house is a region of a circle having a predetermined radius centered on the position of the user. The terminal 4 may calculate the walking distance among the movement distances as the movement distance of the user, and exclude the movement distance in a moving means such as a train or an automobile from the movement distance. For example, the terminal 4 may calculate the moving speed of the user from the position information, and may determine that the user is walking in a case where the moving speed is equal to or less than a threshold.

In the following description, the behavior data indicates the number of steps.

The information processing device 1 includes a processor 2 and a memory 3. The processor 2 is constituted by, for example, a central processing unit (CPU). The processor 2 includes an acquisition unit 21, a preprocessing unit 22, a density calculation unit 23, a correction unit 24, a profiling unit 25, and an output unit 26. The acquisition unit 21 to the output unit 26 are implemented by the CPU executing an information processing program stored in the memory 3. However, this configuration is merely an example, and the acquisition unit 21 to the output unit 26 may be configured by a dedicated hardware circuit. The acquisition unit 21 to the output unit 26 may be dispersedly arranged in a plurality of computers.

The memory 3 includes a nonvolatile storage device such as a solid state drive, and includes a log storage unit 31.

The acquisition unit 21 acquires behavior data indicating a behavior amount of the user. For example, the acquisition unit 21 may acquire behavior data from the terminal 4 via a communication interface (not illustrated). The acquisition unit 21 stores the acquired behavior data in the log storage unit 31. The behavior data includes a time stamp indicating a date and time when the user has acted. In the present disclosure, the behavior data is time-series data in which values indicating the behavior of the user are arranged in order with the lapse of time. The time unit in the behavior data is not limited. For example, the unit may be one day or one hour.

The acquisition unit 21 acquires boarding/alighting point information indicating a boarding/alighting point of the transportation means used by the user. The transportation means is a bus, a railway, an automobile, a motorcycle, a bicycle, a kickboard, a taxi, a vertical take-off and landing aircraft, or the like. The transportation means may be an automobile, a motorcycle, a bicycle, and a kickboard in a sharing service. The boarding/alighting point is, for example, a bus stop, a railway station, a taxi stand, or a vertical take-off and landing aircraft place. The boarding/alighting point may be an installation place of an automobile, a bicycle, and a kickboard in a sharing service. In a case where the transportation means is an automobile, a motorcycle, a bicycle, or a kickboard owned by the user, the boarding/alighting point may be a storage place such as the user's home or a parking lot.

The preprocessing unit 22 reads the behavior data from the log storage unit 31 and performs statistical processing so that the read behavior data can be used for estimation of the interest of the user, thereby calculating the behavior amount data indicating the behavior amount of the user. The behavior amount is a total value of the number of steps of the user per day. Hereinafter, an arbitrary user among the plurality of users is referred to as a user i.

For example, the log storage unit 31 stores behavior data indicating the number of steps per hour. In this case, the preprocessing unit 22 calculates the number of steps of the user i per day by adding the number of steps per hour in the predetermined period. Then, the preprocessing unit 22 calculates a total value of the number of steps of the user i per day as a behavior amount, and calculates behavior amount data by arranging the calculated behavior amounts in time series. The behavior amount data is, for example, time-series data in which the behavior amount (number of steps) on February 5 is 5000 steps, the behavior amount (number of steps) on February 6 is 6200 steps, and the behavior amount (number of steps) on February 7 is 4100 steps.

The behavior amount is not limited to the total value of the number of steps of the user i per day. For example, the behavior amount may be an average value of the number of steps of the user i per day, may be a median value of the number of steps of the user i per day, or may be a mode value of the number of steps of the user i per day. The behavior amount may be the number of going-out, the going-out distance, and the distance in which the user takes a walk per day. The number of steps and the distance in which the user takes a walk are examples of the walking amount.

The predetermined period is a calculation target period of the behavior amount data. The predetermined period is, for example, two years from Jan. 1, 2022 to Jan. 1, 2024. When the predetermined period is long, it is preferable from the viewpoint of noise reduction. However, this is an example, and the behavior amount data may be data including one behavior amount.

The density calculation unit 23 specifies an actual boarding/alighting point region where the boarding/alighting points can be regarded as substantially existing in a predetermined region where the user acts from the positional relationship of the boarding/alighting points indicated by the boarding/alighting point information.

The predetermined region is an attention region in the user's behavior analysis, and is a region in which the user i usually acts. For example, the predetermined region is a city including the user's residential place or a region inside a square having a side of 1 km centered on the user's residential place.

For example, the density calculation unit 23 moves a probe having a shape corresponding to a boarding/alighting point region in a search region including at least a predetermined region where a user acts under the constraint that the boarding/alighting point region including the boarding/alighting point cannot be entered, specifies a region that the probe cannot reach, and specifies the specified region and the boarding/alighting point region as actual boarding/alighting point regions. The shape corresponding to the boarding/alighting point region corresponds to, for example, a similar shape.

The predetermined region is partitioned by a plurality of grids arranged in a matrix. The grid is quadrangular. The probe has a size in which the plurality of grids are arranged in a matrix. The region including the boarding/alighting point is a grid in which the boarding/alighting point is located. Therefore, the probe is formed of a quadrangle having a size larger than that of the boarding/alighting point region. As a result, when the probe is moved in the search region under the constraint, a region that cannot be reached by the probe is generated. The search region is set so as to surround the periphery of the predetermined region, and is a region including a padding region having a shape in which the probe can move and the predetermined region.

The density calculation unit 23 calculates a boarding/alighting point density which is a substantial boarding/alighting point density in a predetermined region based on the predetermined region and the actual boarding/alighting point region. The boarding/alighting point density is, for example, an area ratio of an actual boarding/alighting point region in a predetermined region.

The correction unit 24 corrects the behavior amount included in the behavior amount data in accordance with the boarding/alighting point density. For example, in a case of a user who uses transportation means (hereinafter, referred to as a first transportation means) whose behavior amount tends to decrease as the number of boarding/alighting points increases, the correction unit 24 increases the behavior amount as the boarding/alighting point density increases.

In a case of a user who uses transportation means (hereinafter, referred to as a second transportation means) whose behavior amount tends to increase as the number of boarding/alighting points increases, the correction unit 24 decreases the behavior amount as the boarding/alighting point density increases.

The correction unit 24 may acquire terrain information indicating the distribution of the inclination of the ground in the predetermined region. In this case, the correction unit 24 calculates the inclination degree in the predetermined region from the terrain information, and corrects the boarding/alighting point density such that the smaller the inclination degree, the smaller the boarding/alighting point density. Details of this processing will be described in a first modification described later.

The profiling unit 25 executes profiling for estimating an interest of the user based on the correction behavior amount which is a corrected behavior amount. The profiling unit 25 evaluates the user's interest in health based on the tendency of the correction behavior amount. For example, in a case where the correction behavior amount tends to increase, the profiling unit 25 evaluates that the user's interest in health is increasing. For example, in a case where the correction behavior amount tends to decrease, the profiling unit 25 evaluates that the user's interest in health has decreased.

The output unit 26 outputs a result of the profiling in the profiling unit 25. For example, the output unit 26 may output a result of the profiling to the terminal 4. The output unit 26 may output a result of the profiling to a terminal of an administrator who provides the present service.

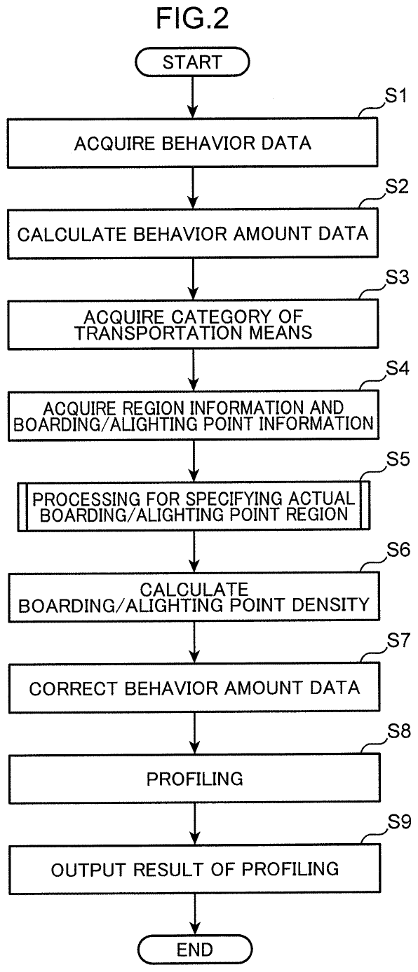

FIG. 2 is a flowchart illustrating an example of processing of the information processing device 1 according to the embodiment of the present disclosure. The following processing is executed for each user.

### Step S1

The acquisition unit 21 acquires behavior data from the terminal 4 and stores the acquired behavior data in the log storage unit 31.

### Step S2

The preprocessing unit 22 reads behavior data from the log storage unit 31 and performs statistical processing on the read behavior data to calculate behavior amount data. The behavior amount is, for example, an average value of the number of steps per day. The behavior amount data is time-series data of the behavior amount.

### Step S3

The acquisition unit 21 acquires a category of transportation means used by the user i. As described above, categories of transportation means are buses, railways, and the like. The acquisition unit 21 may acquire the category of the transportation means input by the user i from the terminal 4. When the category of the transportation means of the user i is registered in the memory 3 in advance, the acquisition unit 21 may acquire the category of the transportation means of the user i from the memory 3. The user can input categories of a plurality of transportation means. In this case, the flowchart of FIG. 2 is executed for each category of the plurality of transportation means.

### Step S4

The acquisition unit 21 acquires region information indicating a predetermined region in which the user i acts. Further, the acquisition unit 21 acquires boarding/alighting point information indicating a boarding/alighting point of the transportation means used by the user. The region information is a two-dimensional coordinate space on which the predetermined region is mapped. The boarding/alighting point information is two-dimensional coordinate data indicating a position of the boarding/alighting point in the predetermined region.

### Step S5

The density calculation unit 23 executes processing of specifying an actual boarding/alighting point region in which an actual boarding/alighting point is specified from a predetermined region using a probe. Hereinafter, in order to simplify the description, it is assumed that the category of the transportation means is a bus and the boarding/alighting point is a bus stop. The predetermined region is a plane ignoring the curvature of the ground caused by the earth being a sphere. That is, the predetermined region is assumed to be an x-y plane in which two axes of an x coordinate and a y coordinate are set. How the origin of the predetermined region and the x axis and the y axis are taken does not affect a processing result to be described later, and thus, the x axis is latitude and the y axis is longitude. In the following description, each of the x axis and the y axis has a length of 100 m per unit. The grid is, for example, a square having a side length of 1.

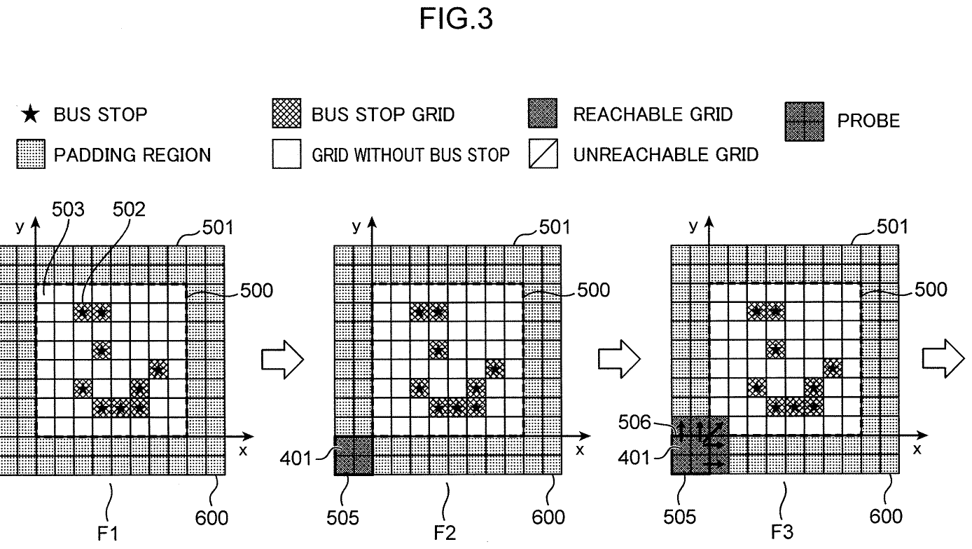

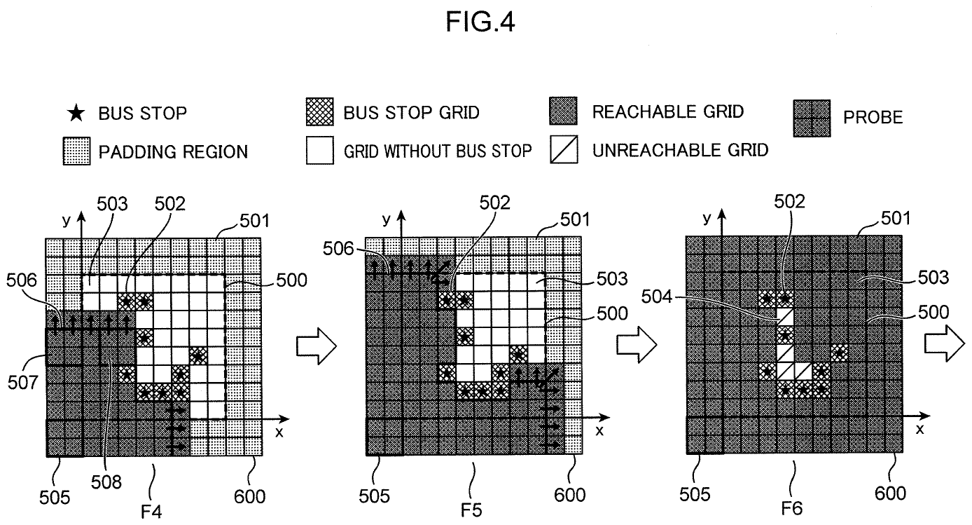

FIGS. 3 and 4 are diagrams illustrating an outline of processing of specifying an actual boarding/alighting point region. A plurality of grids 503 are set in a predetermined region 500. A bus stop grid 502 is a grid 503 including at least one bus stop. Grids 503 other than the bus stop grids 502 in the predetermined region 500 are the grids 503 having no bus stop.

A probe 401 is a probe similar to a probe used in an approximate calculation method of a solvent accessible surface area (SASA). The SASA is the surface area of the molecule accessible to the solvent. In the approximate calculation method of the SASA, a solvent molecule (for example, a water molecule) is used as a probe having a constant radius, and the probe is moved on a molecular surface to calculate an area of a contact portion. In the present embodiment, the actual boarding/alighting point region is specified using the approach of the approximate calculation method of the SASA.

The probe 401 has a square having a side of 2. In the search by the probe 401, the probe 401 is moved throughout the predetermined region 500 under the constraint that the probe 401 cannot enter the bus stop grid 502. Then, after the probe 401 is moved all around and the search is completed, each of the grids 503 is divided into “a grid which the probe can reach” and “a grid which the probe cannot reach”. As a result, as illustrated in FIG. 4, a grid 503 (hereinafter, referred to as an unreachable grid 504) that the probe cannot reach is specified.

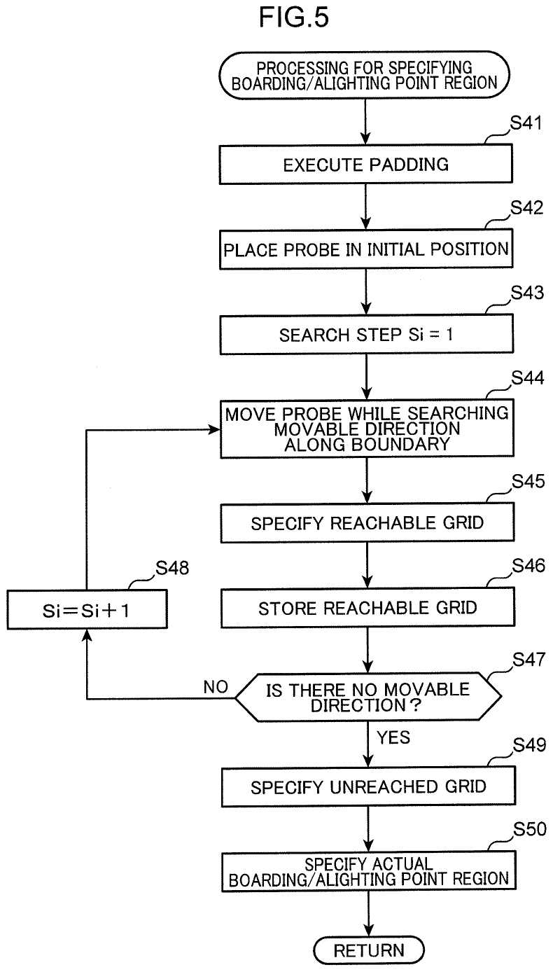

FIG. 5 is a flowchart illustrating details of processing of specifying an actual boarding/alighting point region. Hereinafter, this flowchart will be described with reference to FIGS. 3 and 4.

### Step S41

The density calculation unit 23 executes padding for setting a padding region 501 so as to surround the periphery of the predetermined region 500. The padding region 501 has a shape that allows the probe 401 to always make one round of the predetermined region 500. A state F1 in FIG. 3 indicates the predetermined region 500 after the padding is performed. In this example, the width of the padding region 501 in the x-axis direction is two grids, and the width in the y-axis direction is two grids. That is, the padding region 501 has a shape in which the width in the x-axis direction is larger than the width in the x-axis direction of the probe 401 and the width in the y-axis direction is larger than the width in the y-axis direction of the probe 401. A region including the predetermined region 500 and the padding region 501 is a search region 600.

### Step S42

The density calculation unit 23 disposes the probe 401 at an initial position 505. The initial position 505 is an arbitrary position of the padding region 501. A state F2 in FIG. 3 shows the probe 401 positioned at the initial position 505. The initial position 505 is, for example, a position where both the values of the x axis and the y axis are minimum, that is, a position where the vertex of the left end of the probe 401 is located at the vertex of the left end of the padding region 501.

### Step S43

The density calculation unit 23 sets a search step Si to 1. A state F3 in FIG. 3 is a state in which the search step Si is 1. A state F4 of FIG. 4 is a state in which the search step Si is 6. A state F5 in FIG. 4 is a state in which search step Si is 9.

### Step S44

The density calculation unit 23 specifies a movable direction in which the probe 401 can be moved by one grid from the inside to the outside of a boundary 506 of the searched range in a search step Si-1, and moves the probe 401 in the specified movable direction. In the state F3, the boundary 506 is the upper side and the right side of the probe 401. The boundary 506 in the states F4 and F5 is indicated by a thick line.

For example, in the states F4 and F5, the probe 401 is slid by one grid at a time along the boundary 506 inside the boundary 506, and the movable direction of the probe 401 is searched from the inside to the outside of the boundary 506 at each slide position. Then, the probe 401 is moved in the movable direction specified at each slide position.

In the state F3, since the probe 401 is located at the initial position 505, the upward direction, the right direction, and the diagonally upward right direction are movable directions. In the state F4, for example, when the probe 401 is located at a slide position 507, the upward direction and the diagonally upward right direction are the movable directions. For example, in a case where the probe 401 is located at a slide position 508 in the state F4, only the upward direction becomes the movable direction due to the influence of the bus stop grid 502 located in the periphery.

### Step S45

The density calculation unit 23 specifies a reachable grid. In the state F3, since there is no bus stop grid 502 around the initial position 505, the five grids 503 adjacent to the initial position 505 become reachable grids. Therefore, when the search step Si is 1, the nine grids 503 at the left end painted in dark gray are reachable grids.

In the states F4 and F5, the grid 503 located in the movable direction among the grids 503 in contact with the boundary 506 outside the boundary 506 is a reachable grid. In this way, the reachable grid is filled with the probe 401 so that the reachable grid gradually increases in the upper right direction as the search step Si increases.

### Step S46

The density calculation unit 23 stores the reachable grid in the memory 3. A grid index for identifying each of the grids 503 from the other grids 503 is given to each of the grids. Therefore, the density calculation unit 23 may store the grid index of the reachable grid in the memory 3.

### Step S47

The density calculation unit 23 determines whether there is no movable direction. A state F6 in FIG. 4 indicates the search region 600 after the end of the search. In the state F6, the boundary 506 (not illustrated) is located on the upper side and the right side of the search region 600, and the probe 401 cannot be moved any more. Therefore, there is no movable direction. When there is no movable direction (YES in step S47), the process proceeds to step S49. On the other hand, when there is a movable direction (NO in step S47), the process proceeds to step S48.

### Step S48

The density calculation unit 23 adds 1 to the search step Si. When step S48 ends, the process proceeds to step S44. As a result, the boundary 506 is shifted outward by one grid.

### Step S49

The density calculation unit 23 excludes the padding region 501 and the reachable region from the search region 600, and specifies the remaining grids as the unreachable grids 504 that the probe 401 cannot reach.

### Step S50

The density calculation unit 23 specifies a region including the unreachable grid 504 and the bus stop grid 502 as an actual boarding/alighting point region.

Since the processing of specifying the above-described boarding/alighting point region executes padding, the search region can be searched all over with a finite number of iterations. In addition, since the padding region 501 is set, even if a bus stop exists so as to divide the predetermined region 500 into two, the probe 401 can also move a region where the initial position 505 does not exist among the two divided regions.

### Step S6

The density calculation unit 23 calculates the boarding/alighting point density by using Expression (1). The boarding/alighting point density is an area ratio of the actual boarding/alighting point region in the predetermined region 500.

$$Boarding / alighting point density = Actual boarding / alighting point region / Predetermined region \qquad ( 1 )$$

Note that, in a case where there is a grid corresponding to a lake or a mountain forest to which the user i cannot go in the predetermined region 500, a region including these grids may be excluded from the predetermined region 500.

### Step S7

The correction unit 24 corrects the behavior amount included in the behavior amount data in accordance with the boarding/alighting point density, and calculates a correction behavior amount. The correction includes correction performed in units of users and correction performed in units of different periods of the same user. The former is referred to as inter-user correction, and the latter is referred to as period correction. Hereinafter, the inter-user correction and the period correction will be sequentially described.

In the inter-user correction, the correction unit 24 corrects behavior amount data Fi (time-series data of the number of steps per day) of the user i using a category C of the transportation means and the boarding/alighting point density Di.

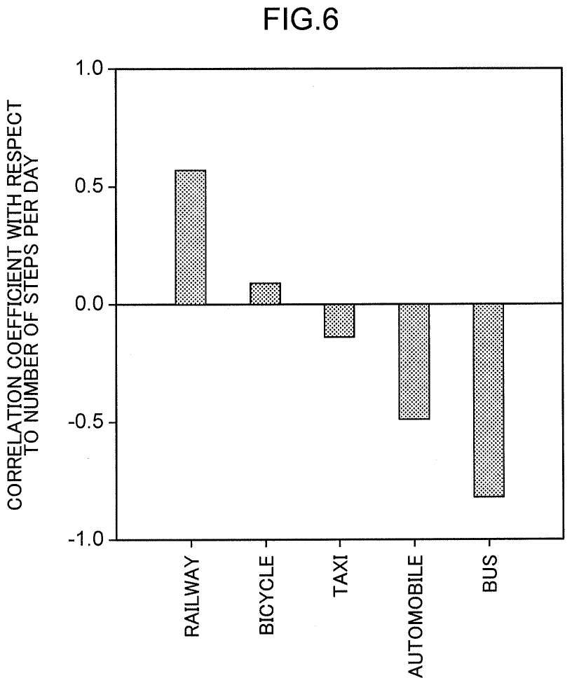

FIG. 6 is a graph showing a correlation coefficient between the number of steps per day and the transportation means. As illustrated in FIG. 6, there are a transportation means having a positive correlation in which the number of steps increases and a transportation means having a negative correlation in which the number of steps decreases. A symbol K(C) for determining whether to increase or decrease the number of steps is defined according to the transportation means. Specifically, a railway having sparse boarding/alighting points and a bicycle moving by human power have a positive correlation with the number of steps. On the other hand, a taxi, an automobile, and a bus have a negative correlation with the number of steps. Note that the sharing service has a negative correlation with the number of steps since there are many boarding/alighting points.

Based on this, the relationship between the category C and the symbol K of the transportation means input in step S2 will be described.

Since the number of steps tends to increase in the transportation means having a positive correlation with the number of steps, the correction unit 24 corrects the number of steps in the decreasing direction. On the other hand, since the number of steps tends to decrease in the transportation means having a negative correlation with the number of steps, the correction unit 24 corrects the number of steps in the increasing direction. Therefore, the symbol K(C) has a sign opposite to the positive or negative of the correlation illustrated in FIG. 6. The category C in which the symbol K(C) is positive is a taxi, an automobile, a motorcycle, a bus, a vertical take-off and landing aircraft, an automobile of a sharing service, a motorcycle of a sharing service, a bicycle of a sharing service, and a kickboard of a sharing service. The category C in which the symbol K(C) is negative is a railway and a bicycle. The transportation means in which the symbol K(C) is positive is the above-described first transportation means. The transportation means in which the symbol K(C) is negative is the above-described second transportation means.

Assuming that the behavior amount data Fi after the correction of the user i is the correction behavior amount data F′i and the correction amount is α, the correction behavior amount data F′i is expressed by Expression (2). The correction behavior amount data F′i is time-series data of the correction behavior amount.

$${F}^{′} i = F i ( 1 + α ) \qquad ( 2 )$$

The correction behavior amount data F′i may be expressed by a power of (1+α). The correction amount α is expressed by Expression (3) using the ratio of the boarding/alighting point density Di at a maximum value Dmax and the symbol K(C).

$$α = β \cdot K ( C ) \cdot Di / Dmax \qquad ( 3 )$$

β is an adjustment coefficient, and is, for example, 0.5. Di is a boarding/alighting point density of the user i.

Dmax is a maximum value of the boarding/alighting point density of all users.

For example, the user i having many bus stops around the residential region is considered. The boarding/alighting point density Di is set to 80% of the maximum value Dmax, and the number of steps (=behavior amount) per day on a certain day is set to 8000 steps. In this case, the correction behavior amount data F′i is F′i=8000(1+0.5·0.8)=11200 steps.

In this way, the number of steps of the user living in the region where the number of steps tends to decrease due to the traffic environment is increased. As a result, the influence of the variation component according to the transportation means is removed from the number of steps, and the number of steps between the users can be fairly compared. The correction unit 24 may execute such correction for all the behavior amounts (the number of steps per day) included in the behavior amount data Fi.

### Step S8

The profiling unit 25 executes profiling using the correction behavior amount data F′i. Specific examples of profiling have been described above.

### Step S9

The output unit 26 outputs the result of the profiling to the terminal 4 or the like.

As described above, according to the present embodiment, the behavior amount of the user is corrected in accordance with the boarding/alighting point density of the transportation means, and the interest of the user is estimated based on the correction behavior amount which is a corrected behavior amount. As a result, it is possible to estimate the interest of the user by suppressing the influence of the variation component of the behavior amount of the user according to the traffic environment of the region. Furthermore, in the present embodiment, an actual boarding/alighting point region that can be regarded as substantially existing is specified from a positional relationship of boarding/alighting points, and a boarding/alighting point density that is a substantial boarding/alighting point density is calculated from the region and the actual boarding/alighting point region. Therefore, the interest of the user can be accurately estimated using the substantial boarding/alighting point density.

### First Modification

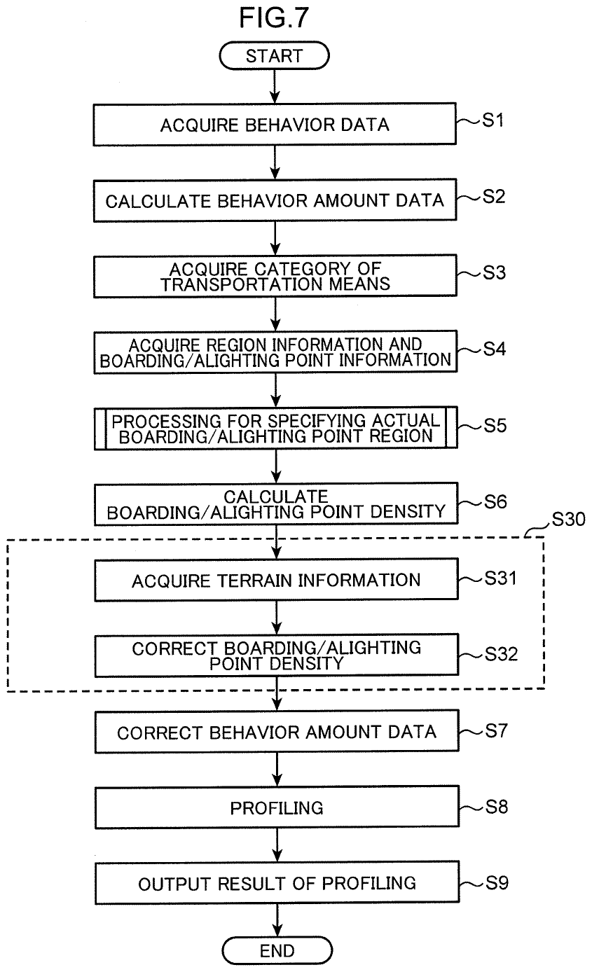

Next, a first modification of the flowchart of FIG. 2 will be described. FIG. 7 is a flowchart in the first modification of the embodiment. In FIG. 7, the same processing as that in FIG. 2 is denoted by the same step number, and description thereof will be omitted.

In the flowchart of the first modification, the processing of step S30 is further added to FIG. 2. Step S30 is a process of correcting the boarding/alighting point density Di using the terrain information.

### Step S31

The correction unit 24 acquires terrain information. The terrain information includes an inclination angle of each of the grids 503 in the predetermined region 500. The terrain information is stored in the memory 3 in advance. Therefore, the correction unit 24 may acquire the terrain information from the memory 3.

The correction unit 24 calculates the inclination degree of the predetermined region from the terrain information. The inclination degree is, for example, an average inclination degree or a median value of inclination angles in the predetermined region 500. The correction unit 24 may calculate the average inclination degree by averaging the inclination angles of the grids 503. The terrain information may be an elevation difference between each of the grids 503 and the adjacent grid 503. In this case, the correction unit 24 may calculate an average value or a median value of elevation differences of each of the grids 503 as the inclination degree.

### Step S32

The correction unit 24 corrects the boarding/alighting point density Di using the inclination degree.

In flat regions, the use of bicycles tends to increase. For this reason, the frequency of use of the bus decreases although there are many bus stops. As a result, the variation component corresponding to the transportation means in the flat region tends to increase as compared with the region having a high inclination degree. In order to correct such an increasing tendency, the correction unit 24 corrects the boarding/alighting point density Di using the inclination degree. The corrected boarding/alighting point density D′i is expressed by Expression (4).

$${D}^{′} i = D i ( 1 - γ ) \qquad ( 4 )$$

The density correction amount γ is expressed by expression (5).

$$γ = δ ( 1 - G i / G max ) \qquad ( 5 )$$

Gi is an inclination degree. Gmax is the maximum value of the inclination degrees for all users. δ is an adjustment coefficient of correction, and is, for example, 0.5.

Since the density correction amount γ decreases as the inclination degree Gi increases, the boarding/alighting point density D′i decreases accordingly. In the first modification, the correction unit 24 substitutes the boarding/alighting point density D′i into Di of Expression (3) to obtain the correction amount α. When the boarding/alighting point density D′i decreases, the correction amount α decreases. Therefore, the correction amount α in the flat region is smaller than the correction amount α in the region where the inclination degree is high. Therefore, in consideration of a decrease in the frequency of use of the bus in a flat region, the increase in the number of steps can be reduced.

For example, the user i who lives in a flat region is considered. The inclination degree Gi is 20% of the maximum value Gmax. The boarding/alighting point density Di before the correction is set to 0.4. In this case, the boarding/alighting point density D′i=0.4·(1−0.5·(1−0.2))=0.24. In this way, the frequency of use of the bus decreases as the frequency of use of the bicycle increases for the user who lives in a flat region. In view of this, in the first modification, the boarding/alighting point density D′i can be lowered, and the raised amount of the number of steps can be reduced. As a result, the users can be compared using the number of steps from which the topographical factor has been removed. When step S30 is not executed, the density correction amount γ is 0.

Next, the period correction will be described. In the period correction, the behavior amount data Fi in both periods is corrected in order to compare the behavior amount data Fi in two or more periods in the same user. In the period correction, the index of the user i in the inter-user correction may be replaced with indexes of a plurality of periods of the same user.

That is, the processor 2 cuts out two or more periods from the behavior amount data Fi calculated in step S2. Then, the processor 2 applies the processing of FIG. 2 or FIG. 7 to each cut-out period. As a result, in each period, the correction behavior amount from which the variation component corresponding to the transportation means is removed is obtained.

For example, when comparing the past and the present, the processor 2 divides the behavior amount data Fi in the predetermined period into an old period and a new period at the center of the time series. Then, the processor 2 obtains correction behavior amount data F′i from which the variation component corresponding to the transportation means is removed for each of the period on the old side and the period on the new side. Then, the information processing device 1 presents the correction behavior amount data F′i in both periods to the user, for example. As a result, for example, even in a case where the user moves, a substantial behavior amount of the user can be obtained. Note that the period during which the behavior amount data Fi is cut out may be, for example, monthly, semi-annually, or yearly. The length of the cut-out period can be designated by the administrator or the user.

### Second Modification

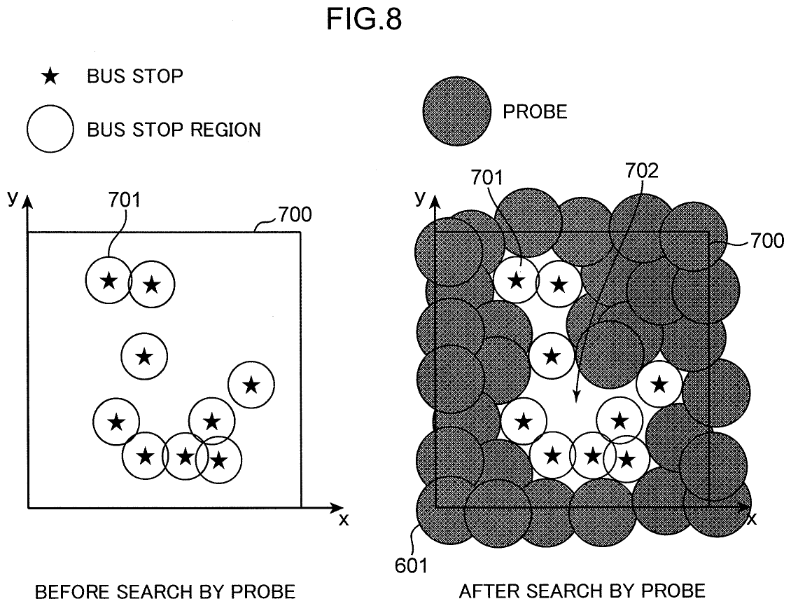

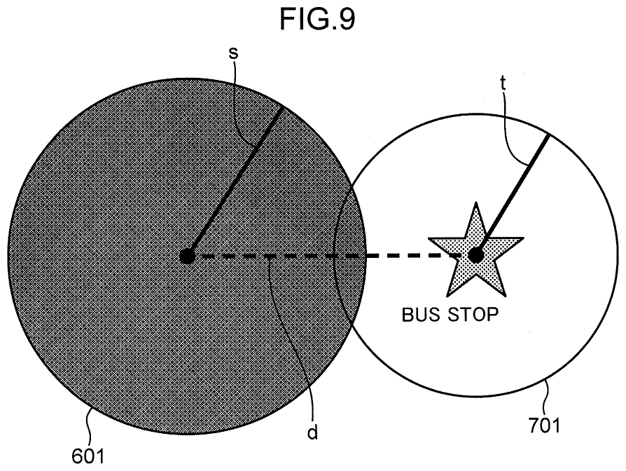

In a second modification, a circular probe is used instead of the quadrangular probe. FIGS. 8 and 9 are explanatory diagrams of processing of the second modification. A bus stop indicated by a star sign is arranged in the predetermined region 700. A bus stop region 701 is a circle centered on a bus stop. A radius t of the bus stop region 701 is, for example, 0.5. The density calculation unit 23 specifies an actual boarding/alighting point region using a circular probe 601. The radius s of the probe 601 is, for example, 1.

Also in the second modification, the flowchart of FIG. 5 is applicable to the processing of specifying an actual boarding/alighting point. However, as illustrated in FIG. 9, when the distance d between the probe 601 and the bus stop region 701 is smaller than the sum (=s+t) of the radius s of the probe 601 and the radius t of the bus stop region 701, the density calculation unit 23 determines that the probe 601 overlaps with the bus stop region 701. Therefore, the density calculation unit 23 moves the probe 601 in the predetermined region 700 under the condition that the sum is equal to or larger than the distance d. When the center of the probe 601 is within the predetermined region 700, the density calculation unit 23 allows the probe 601 to protrude from the predetermined region 700.

The density calculation unit 23 specifies a region where the probe 601 cannot move in the predetermined region 700 as a non-arrival region 702. In FIG. 8, since the gray region is a region where the probe 601 can move, in the predetermined region 700, a region other than the bus stop region 701 and the gray region is specified as the non-arrival region 702. The density calculation unit 23 specifies a region including the bus stop region 701 and the non-arrival region 702 as an actual boarding/alighting point region. Thereafter, the density calculation unit 23 calculates the boarding/alighting point density Di or the boarding/alighting point density D′i by using the actual boarding/alighting point region.

Since the subsequent processing is the same as that of the embodiment, the description thereof will be omitted. In the case of using the probe 601, it is possible to more accurately specify the actual boarding/alighting point region and accurately estimate the user's interest.

### APPLICATION EXAMPLE

Each application example of the present disclosure will be described below.

The application is a health promotion application of a local community. The user can check the number of steps of the user with reference to the application. The processing of the present disclosure is applied to such an application. The user in the application is a person belonging to a local community (for example, a resident of a town). The user uses the application for a long time. A user A who is interested in his/her health is a resident of a region X where a bus network is developed and there are many bus stops. The user A frequently uses a bus in daily life. For example, the user can go to the city hall as the final destination from a bus stop near the home by using a bus. Therefore, the user A almost does not have to walk. On the other hand, a user B is a resident of the region Y where the railroad network is developed. The residence of the user B is far from the nearest station. Therefore, the user B walks in the section from the home to a station far from the home and the section from the station close to the destination to the final destination. Here, in a case where the number of steps of the user A is smaller than that of the user B, it is difficult to distinguish whether the user A simply dislikes walking or is influenced by transportation means. Therefore, the interest of the user A in health cannot be accurately estimated from the increase or decrease in the number of steps. Furthermore, in a case where the effect of increasing the number of steps in the campaign for encouraging an increase in the number of steps is verified, since the number of steps of the user A and the user B includes a variation component corresponding to transportation means, the comparison of the number of steps cannot be accurately performed. As a result, it is not possible to accurately estimate both health concerns.

On the other hand, in the user profiling in the present disclosure, since the variation component due to the transportation means is removed from the number of steps, the interest of the user can be estimated with high accuracy. As a result, it is possible to display the number of steps from which the variation component due to the transportation means has been removed to the user. As a result, the user can understand his/her own walking effort. Therefore, even when the user moves to a city having a large difference in traffic environment, the user actively uses the application.

An example of specific processing of this example will be sequentially described with reference to the configuration of the present embodiment. A resident in a certain local community uses a smartphone as the terminal 4. Then, an application intended to promote the health of the local community has been installed on the smartphone. The acquisition unit 21 acquires the number of steps of the user of the application and stores the number in the log storage unit 31. The log storage unit 31 may be a database constructed on a cloud.

The information processing device 1 executes processing of estimating an interest of a user at 23:00 every day. This processing is called as batch processing at 23:00. The preprocessing unit 22 calculates the behavior amount data Fi by calculating the total number of steps per day from the behavior data acquired from the log storage unit 31. The correction unit 24 corrects the number of steps based on the behavior amount data Fi calculated by the preprocessing unit 22 so that a variation component of the number of steps by the transportation means according to the transportation means is removed. The profiling unit 25 estimates the interest of the user based on the correction behavior amount data F′i. The output unit 26 notifies the administrator of the estimation result. As a result, the administrator can confirm whether the interest in health of the user who uses the application for the most recent month has increased from before. When the interest in health is decreasing, the administrator notifies the user of a notification or event for raising the interest in health.

The present disclosure is useful for estimating the interest of the user with high accuracy.

1. An information processing device comprising a processor, wherein
the processor is configured to execute:
acquiring behavior amount data indicating a behavior amount of a user;
acquiring boarding/alighting point information indicating a boarding/alighting point of a transportation means used by the user;
specifying an actual boarding/alighting point region where the boarding/alighting point is regarded as substantially existing in a predetermined region where the user acts, from a positional relationship between the boarding/alighting points;
calculating a boarding/alighting point density which is a substantial density of the boarding/alighting points in the predetermined region based on the predetermined region and the actual boarding/alighting point region;
correcting the behavior amount indicated by the behavior amount data according to the boarding/alighting point density;
executing profiling for estimating an interest of the user based on a correction behavior amount that is the corrected behavior amount; and
outputting a result of the profiling.

2. The information processing device according to claim 1, wherein the behavior amount is calculated by statistically processing behavior data indicating a behavior of the user.

3. The information processing device according to claim 1, wherein the boarding/alighting point includes a bus stop.

4. The information processing device according to claim 1, wherein
the correcting of the behavior amount includes
acquiring terrain information indicating a distribution of inclinations in the predetermined region, and
calculating an inclination degree of the predetermined region based on the terrain information, and correcting the boarding/alighting point density so that the smaller the inclination degree, the smaller the boarding/alighting point density.

5. The information processing device according to claim 1, wherein the specifying of the actual boarding/alighting point region includes, under a constraint that a boarding/alighting point region including the boarding/alighting point cannot be entered, moving a probe having a shape corresponding to the boarding/alighting point region in a search region including at least the predetermined region to specify a region that the probe cannot reach, and specifying the specified region and the boarding/alighting point region as the actual boarding/alighting point regions.

6. The information processing device according to claim 5, wherein
the boarding/alighting point region is a quadrangle, and
the probe is a quadrangle larger in size than the boarding/alighting point region.

7. The information processing device according to claim 5, wherein
the boarding/alighting point region is circular, and
the probe is circular.

8. The information processing device according to claim 5, wherein the search region is set so as to surround a periphery of the predetermined region, and includes a padding region having a shape in which the probe is movable, and the predetermined region.

9. The information processing device according to claim 1, wherein
the correcting of the behavior amount includes
in a case of a user who uses a transportation means having a tendency that the behavior amount decreases as the number of the boarding/alighting points increases, increasing the behavior amount as the boarding/alighting point density increases.

10. The information processing device according to claim 1, wherein
the correcting of the behavior amount includes
in a case of a user who uses a transportation means having a tendency that the behavior amount increases as the number of the boarding/alighting points increases, decreasing the behavior amount as the boarding/alighting point density increases.

11. The information processing device according to claim 1, wherein the behavior amount is a walking amount.

12. An information processing method executed by a computer, the method comprising:
acquiring behavior amount data indicating a behavior amount of a user;
acquiring boarding/alighting point information indicating a boarding/alighting point of a transportation means used by the user;
specifying an actual boarding/alighting point region where the boarding/alighting point is regarded as substantially existing in a predetermined region where the user acts, from a positional relationship between the boarding/alighting points;
calculating a boarding/alighting point density which is a substantial density of the boarding/alighting points in the predetermined region based on the predetermined region and the actual boarding/alighting point region;
correcting the behavior amount indicated by the behavior amount data according to the boarding/alighting point density;
executing profiling for estimating an interest of the user based on a correction behavior amount that is the corrected behavior amount; and
outputting a result of the profiling.

13. A non-transitory computer-readable recording medium that records an information processing program for causing a computer to execute:
acquiring behavior amount data indicating a behavior amount of a user;
acquiring boarding/alighting point information indicating a boarding/alighting point of a transportation means used by the user;
specifying an actual boarding/alighting point region where the boarding/alighting point is regarded as substantially existing in a predetermined region where the user acts, from a positional relationship between the boarding/alighting points;
calculating a boarding/alighting point density which is a substantial density of the boarding/alighting points in the predetermined region based on the predetermined region and the actual boarding/alighting point region;
correcting the behavior amount indicated by the behavior amount data according to the boarding/alighting point density;
executing profiling for estimating an interest of the user based on a correction behavior amount that is the corrected behavior amount; and
outputting a result of the profiling.
